(19) United States
(12) Patent Application Publication
(10) Pub. No.: US 2026/0279681 A1
(43) Pub. Date: Sep. 17, 2026

(54) MULTILAYER CERAMIC CAPACITOR

(71) Applicant: Murata Manufacturing Co., Ltd., Nagaokakyo-shi (JP)

(72) Inventor: Mitsuhiro OKUBO, Nagaokakyo-shi (JP)

(21) Appl. No.: 19/533,888

(22) Filed: Feb. 9, 2026

(30) Foreign Application Priority Data
Mar. 14, 2025 (JP) 2025-041595

(51) Int. Cl. H01G 4/30; H01G 4/008; H01G 4/012; H01G 4/232

(52) U.S. Cl. CPC H01G 4/30; H01G 4/0085; H01G 4/012; H01G 4/2325

(57) ABSTRACT

A multilayer ceramic capacitor includes a multilayer body, first and second inner electrode layers, and first and second outer electrodes. The multilayer body includes first to sixth surfaces. The first inner electrode layer extends to the third surface. The second inner electrode layer extends to the third surface. The first outer electrode is on the third surface and connected to the first inner electrode layer. The second outer electrode is on the fourth surface and connected to the second inner electrode layer. The first inner electrode layer includes a first extended region. The second inner electrode layer includes a second extended region. The first extended region and the second extended region each include a shrinkage-mitigating portion in a central portion in a second direction and exposed on at least one of the third or fourth surfaces.

### CROSS REFERENCE TO RELATED APPLICATIONS

This application claims the benefit of priority to Japanese Patent Application No. 2025-041595 filed on Mar. 14, 2025. The entire contents of this application are hereby incorporated herein by reference.

### BACKGROUND OF THE INVENTION

### 1. Field of the Invention

The present invention relates to multilayer ceramic capacitors.

### 2. Description of the Related Art

Multilayer ceramic capacitors are commonly used as decoupling capacitors to stabilize a power supply voltage supplied to an integrated circuit (IC) that operates at high speed.

Such a multilayer ceramic capacitor includes an inner layer portion where dielectric layers and inner electrodes are stacked alternately. Dielectric layers serving as outer layer portions are disposed on the top and bottom of the inner layer portion to form a cuboid multilayer body, and an outer electrode is disposed on each longitudinal end surface of the multilayer body to form the multilayer ceramic capacitor. The multilayer ceramic capacitor includes the outer layer portions positioned to sandwich the inner layer portion from opposite sides (see, for example, Japanese Unexamined Patent Application Publication No. 2019-179928).

To decompose the binder used during manufacture of such a multilayer ceramic capacitor, heating needs to be applied at a temperature higher than or equal to about 800° C. and lower than or equal to about 900° C. to remove the binder. However, during the binder removal, only Ni in the inner electrode layers undergoes shrinkage. This may cause stress to develop between each outer layer portion, which does not shrink, and the inner layer portion, which shrinks. The stress may lead to cracking.

### SUMMARY OF THE INVENTION

Example embodiments of the present invention provide multilayer ceramic capacitors each of which reduces or prevents a difference in shrinkage between the outer and inner layer portions of the multilayer body to thus reduce or prevent an occurrence of cracking within the multilayer body.

A multilayer ceramic capacitor according to an example embodiment of the present invention includes a multilayer body, a first inner electrode layer, a second inner electrode layer, a first outer electrode, and a second outer electrode. The multilayer body includes a plurality of dielectric layers that are stacked, and a plurality of inner electrode layers each stacked on a corresponding one of the plurality of dielectric layers. The multilayer body includes a first surface, a second surface, a third surface, a fourth surface, a fifth surface, and a sixth surface. The first surface and the second surface are opposed to each other in a stacking direction. The third surface and the fourth surface are opposed to each other in a first direction orthogonal or substantially orthogonal to the stacking direction. The fifth surface and the sixth surface are opposed to each other in a second direction orthogonal or substantially orthogonal to the stacking direction and to the first direction. The first inner electrode layer is provided on a corresponding one of the plurality of dielectric layers, and extends to the third surface. The second inner electrode layer is provided on a corresponding one of the plurality of dielectric layers, and extends to the third surface. The first outer electrode is provided on the third surface, and connected to the first inner electrode layer. The second outer electrode is provided on the fourth surface, and connected to the second inner electrode layer. The first inner electrode layer includes a first opposed region opposed to the second inner electrode layer, and a first extended region located between the first opposed region and the third surface. The second inner electrode layer includes a second opposed region opposed to the first inner electrode layer, and a second extended region located between the second opposed region and the fourth surface. The first extended region includes a first extended portion connected to the first outer electrode. The second extended region includes a second extended portion connected to the second outer electrode. The first extended region and the second extended region each include a shrinkage-mitigating portion located in a central portion in the second direction and exposed on at least one of the third surface or the fourth surface. The shrinkage-mitigating portion includes a main metal component that is less susceptible to shrinkage than a metal component of each of the first inner electrode layer and the second inner electrode layer.

In a multilayer ceramic capacitors according to an example embodiment of the present invention, the first extended region includes the first extended portion connected to the first outer electrode, the second extended region includes the second extended portion connected to the second outer electrode, and the first extended region and the second extended region each include the shrinkage-mitigating portion located in the central portion in the second direction and exposed on at least one of the third surface or the fourth surface. The shrinkage-mitigating portion includes a main metal component that is less susceptible to shrinkage than a metal component of each of the first inner electrode layer and the second inner electrode layer. The above-described configuration reduces or prevents a difference in shrinkage between the outer layer portion and the capacitance-generating portion, and thus makes it possible to reduce or prevent the occurrence of cracking within the multilayer body. Further, the shrinkage-mitigating portion is located in the central portion of the first extended region in the second direction, and in the central portion of the second extended region in the second direction. The presence of the shrinkage-mitigating portion in the central portion, which is a portion susceptible to an influence of shrinkage, reduces or prevents a difference in shrinkage between the outer layer portion and the capacitance-generating portion, and thus makes it possible to reduce or prevent an occurrence of cracking within the multilayer body.

Example embodiments of the present invention provide multilayer ceramic capacitors each of which reduces or prevents a difference in shrinkage between outer and inner layer portions of a multilayer body to thus reduce or prevent an occurrence of cracking within the multilayer body.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view of an example of a multilayer ceramic capacitor according to an example embodiment of the present invention.

FIG. 2 is a front view of an example of a multilayer ceramic capacitor according to an example embodiment of the present invention.

FIG. 3 is a cross-sectional view taken along a line III-III in FIG. 1.

FIG. 4 is a cross-sectional view taken along a line IV-IV in FIG. 1.

FIG. 5 is a cross-sectional view taken along a line V-V in FIG. 2.

FIG. 6 is a cross-sectional view taken along a line VI-VI in FIG. 2.

FIG. 7 is a cross-sectional view, corresponding to the cross-sectional view in FIG. 5, of Modification 1 of an example embodiment of the present invention.

FIG. 8 is a cross-sectional view, corresponding to the cross-sectional view in FIG. 6, of Modification 1 of an example embodiment of the present invention.

FIG. 9 is a cross-sectional view, corresponding to the cross-sectional view in FIG. 5, of Modification 2 of an example embodiment of the present invention.

FIG. 10 is a cross-sectional view, corresponding to the cross-sectional view in FIG. 6, of Modification 2 of the example embodiment of the present invention.

FIG. 11 is a cross-sectional view, corresponding to the cross-sectional view in FIG. 5, of Modification 3 of an example embodiment of the present invention.

FIG. 12 is a cross-sectional view, corresponding to the cross-sectional view in FIG. 6, of Modification 3 of an example embodiment of the present invention.

### DETAILED DESCRIPTION OF THE EXAMPLE EMBODIMENTS

Example embodiments of the present invention will be described in detail below with reference to the drawings.

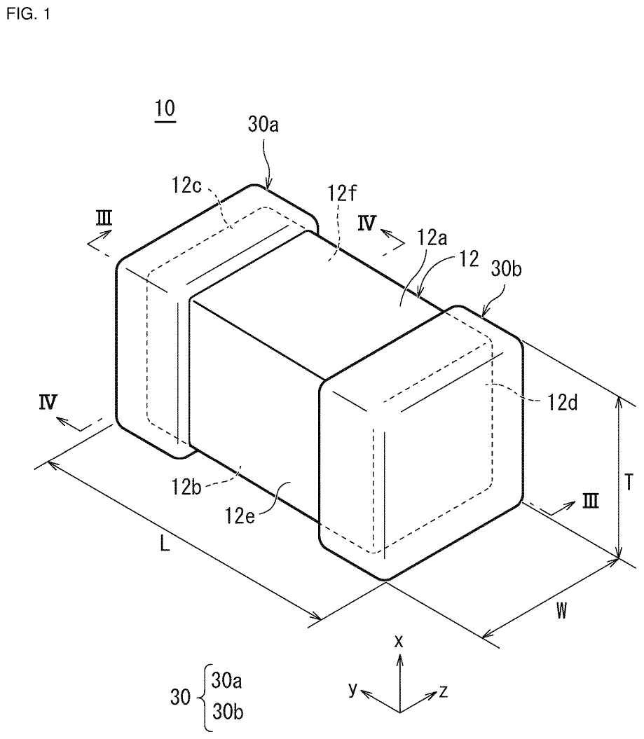

As a multilayer ceramic capacitor according to an example embodiment of the present invention, a multilayer ceramic capacitor 10 will now be described with reference to FIGS. 1 to 6.

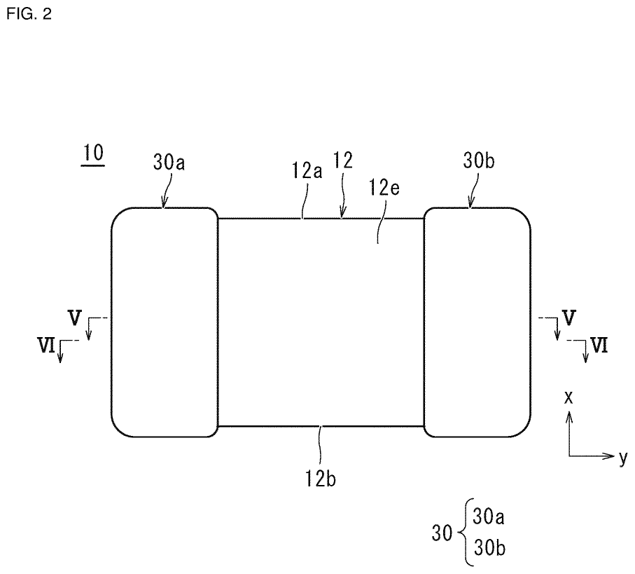

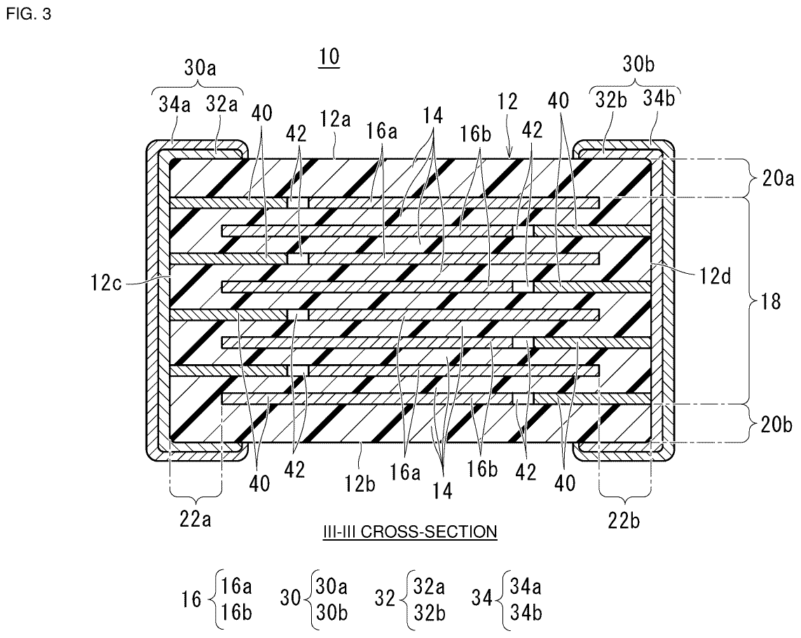

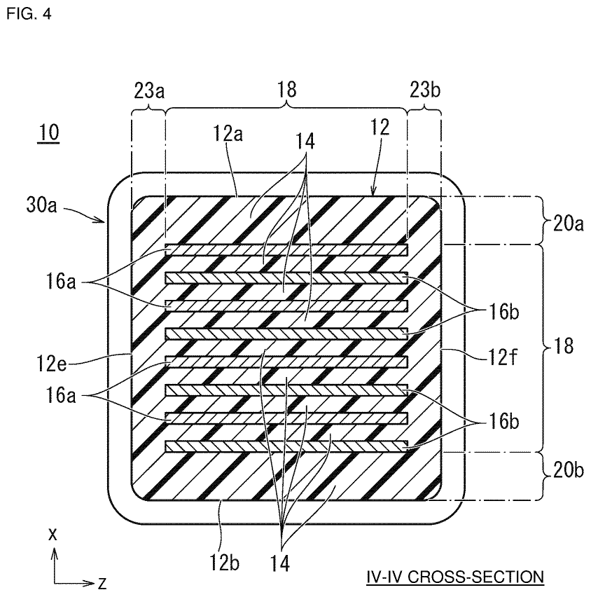

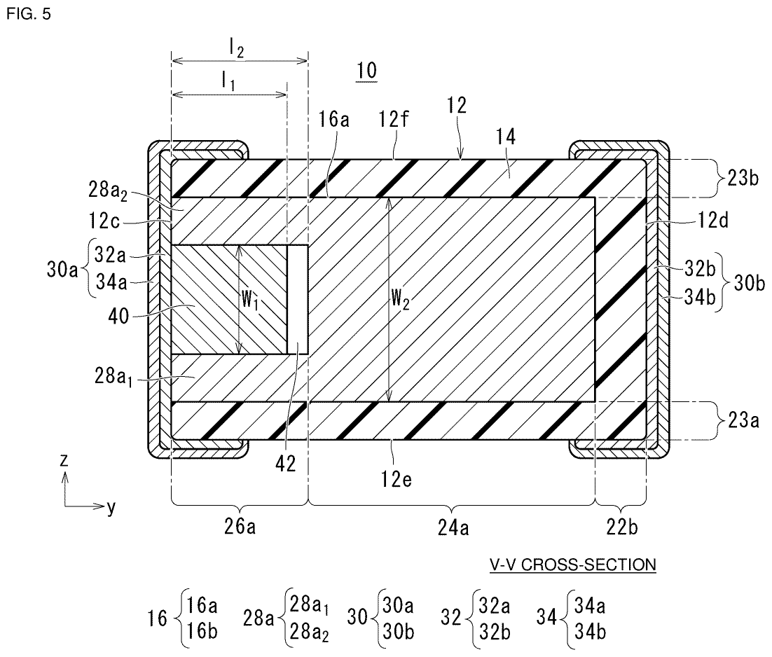

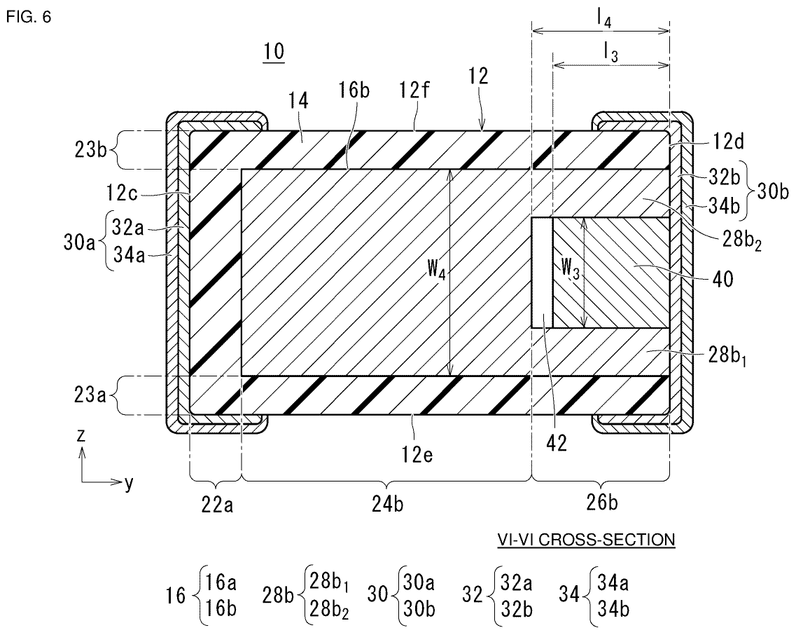

FIG. 1 is an external perspective view of an example of the multilayer ceramic capacitor according to the present example embodiment of the present invention. FIG. 2 is a front view of an example of the multilayer ceramic capacitor according to the present example embodiment of the present invention. FIG. 3 is a cross-sectional view taken along a line III-III in FIG. 1. FIG. 4 is a cross-sectional view taken along a line IV-IV in FIG. 1. FIG. 5 is a cross-sectional view taken along a line V-V in FIG. 2. FIG. 6 is a cross-sectional view taken along a line VI-VI in FIG. 2.

As illustrated in FIG. 1, the multilayer ceramic capacitor 10 includes a multilayer body 12 having a cuboid shape, and an outer electrode 30 disposed on the surface of the multilayer body 12.

The multilayer body 12 includes a plurality of dielectric layers 14 that are stacked, and a plurality of inner electrode layers 16 each stacked on the corresponding one of the dielectric layers 14. Each of the inner electrode layers 16 includes at least one first inner electrode layer 16a and at least one second inner electrode layer 16b. Details of the first inner electrode layer 16a and the second inner electrode layer 16b will be described later.

The multilayer body 12 includes a first surface 12a, a second surface 12b, a third surface 12c, a fourth surface 12d, a fifth surface 12e, and a sixth surface 12f. The first surface 12a and the second surface 12b are opposed to each other in a stacking direction x. The third surface 12c and the fourth surface 12d are opposed to each other in a first direction y, which is orthogonal or substantially orthogonal to the stacking direction x. The fifth surface 12e and the sixth surface 12f are opposed to each other in a second direction z, which is orthogonal or substantially orthogonal to the stacking direction x and the first direction y.

Preferably, the multilayer body 12 has a cuboid shape, and is rounded at corners and edges thereof. A corner is where three surfaces of the multilayer body 12 meet. An edge is where two surfaces of the multilayer body 12 meet. The first surface 12a and the second surface 12b, the third surface 12c and the fourth surface 12d, and the fifth surface 12e and the sixth surface 12f may include, for example, projections and depressions in a portion or in the entirety thereof.

The multilayer body 12 includes a capacitance-generating portion 18, and a first outer layer portion 20a and a second outer layer portion 20b, which are positioned to sandwich the capacitance-generating portion 18 in the stacking direction x. The first outer layer portion 20a is located adjacent to the first surface 12a, and the second outer layer portion 20b is located adjacent to the second surface 12b.

In the capacitance-generating portion 18, the first inner electrode layer 16a and the second inner electrode layer 16b are stacked alternately with the dielectric layer 14 interposed therebetween.

The first outer layer portion 20a, which is located adjacent to the first surface 12a of the multilayer body 12, includes a group of dielectric layers 14 located between the first surface 12a and a portion of the capacitance-generating portion 18 positioned closest to the first surface 12a. The second outer layer portion 20b, which is located adjacent to the second surface 12b of the multilayer body 12, includes a group of dielectric layers 14 located between the second surface 12b and a portion of the capacitance-generating portion 18 positioned closest to the second surface 12b. Further, a region sandwiched between the first outer layer portion 20a and the second outer layer portion 20b defines the capacitance-generating portion 18.

As illustrated in FIG. 3, the multilayer body 12 includes end portions (L-gaps) 22a and 22b. The end portion 22a is located between the capacitance-generating portion 18 and the third surface 12c. The end portion 22b is located between the capacitance-generating portion 18 and the fourth surface 12d.

As illustrated in FIG. 4, the multilayer body 12 includes end portions (W-gaps) 23a and 23b. The end portion 23a is located between the capacitance-generating portion 18 and the fifth surface 12e. The end portion 23b is located between the capacitance-generating portion 18 and the sixth surface 12f. The dielectric layer 14 may be made of, for example, a dielectric material defining and functioning as a ceramic material. Such a dielectric material may be a dielectric ceramic material including, for example, a component such as BaTiO₃, CaTio₃, SrTiO₃, or CaZrO₃. If the material to be used includes the dielectric material as its main component, then, depending on desired characteristics of the multilayer body 12, the material to be used may include a minor component such as, for example, a Mn compound, an Fe compound, a Cr compound, a Co compound, or a Ni compound added at a content less than that of the main component.

Preferably, the dielectric layer 14 of the multilayer body 12 has a post-firing thickness in an approximate range of greater than or equal to about 0.50 μm and less than or equal to about 3.00 μm, for example.

The number of dielectric layers 14 to be stacked is preferably, for example, greater than or equal to 300 and less than or equal to 1500. The number of dielectric layers 14 is the sum of the number of dielectric layers 14 in the capacitance-generating portion 18 and the number of dielectric layers in the first outer layer portion 20a and the second outer layer portion 20b.

The multilayer body 12 includes, as the inner electrode layers 16, a plurality of first inner electrode layers 16a and a plurality of second inner electrode layers 16b. The first inner electrode layers 16a and the second inner electrode layers 16b are parallel or substantially parallel to the first surface 12a and the second surface 12b, and embedded such that the first and second electrode layers 16a and 16b are arranged alternately in the stacking direction x of the multilayer body 12 with the dielectric layer 14 sandwiched therebetween.

Each first inner electrode layer 16a is disposed on the corresponding one of the dielectric layers 14, and located within the multilayer body 12. The first inner electrode layer 16a includes a first opposed region 24a and a first extended region 26a. The first opposed region 24a is a region opposed to the second inner electrode layer 16b. The first extended region 26a is a region that is located adjacent to one end of the first inner electrode layer 16a, and that extends from the first opposed region 24a to the third surface 12c of the multilayer body 12.

The first extended region 26a includes a first extended portion 28a and a shrinkage-mitigating portion 40. The shrinkage-mitigating portion 40 of the first extended region 26a is disposed in a central portion of the first extended region 26a in the second direction z, and exposed on the third surface 12c. The first extended portion 28a is disposed in each end portion of the first extended region 26a in the second direction z, and exposed on the third surface 12c. The first extended portion 28a includes a first extended portion 28a1 located adjacent to the fifth surface 12e, and a first extended portion 28a2 located adjacent to the sixth surface 12f. Alternatively, the first extended portion 28a may be located adjacent to only one side portion of the first extended region 26a in the second direction z.

The first opposed region 24a and the first extended portion 28a are preferably integral with each other.

The shrinkage-mitigating portion 40 disposed in the first extended region 26a is connected to the first extended portion 28a. Specifically, the shrinkage-mitigating portion 40 disposed in the first extended region 26a is connected at its edge adjacent to the fifth surface 12e to the first extended portion 28a1, and connected at its edge adjacent to the sixth surface 12f to the first extended portion 28a2.

As described above, the shrinkage-mitigating portion 40 disposed in the first extended region 26a is connected to the first extended portion 28a. This results in an increased joint area with the outer electrode 30, which makes it possible to improve resistance characteristics such as ESR.

The shrinkage-mitigating portion 40 disposed in the first extended region 26a may be positioned to overlap a portion of the first extended portion 28a.

Preferably, the first opposed region 24a, and the shrinkage-mitigating portion 40 disposed in the first extended region 26a are not connected to each other, and a clearance region 42 is provided therebetween.

Due to the presence of the clearance region 42 between the first opposed region 24a, and the shrinkage-mitigating portion 40 disposed in the first extended region 26a, the first opposed region 24a and the shrinkage-mitigating portion 40 do not overlap. This makes it possible to reduce or prevent the risk of deterioration in reliability that would occur as an end portion of the first opposed region 24a is locally pressed down.

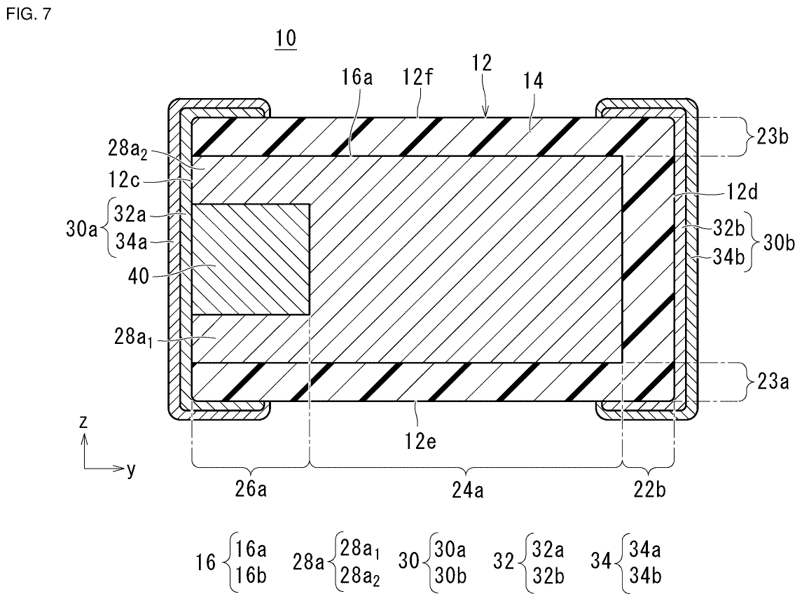

In an alternative configuration, as illustrated in FIG. 7, the first opposed region 24a, and the shrinkage-mitigating portion 40 disposed in the first extended region 26a may be connected to each other, and the first extended portion 28a, and the shrinkage-mitigating portion 40 disposed in the first extended region 26a may be connected to each other.

According to the above-described configuration, the first opposed region 24a, and the shrinkage-mitigating portion 40 disposed in the first extended region 26a are connected to each other, and the first extended portion 28a, and the shrinkage-mitigating portion 40 disposed in the first extended region 26a are connected to each other. This allows for a wider current path in the first extended region 26a, which makes it possible to further improve resistance characteristics such as ESR, for example.

The shrinkage-mitigating portion 40 disposed in the first extended region 26a may be positioned to overlap a portion of the first opposed region 24a and a portion of the first extended portion 28a.

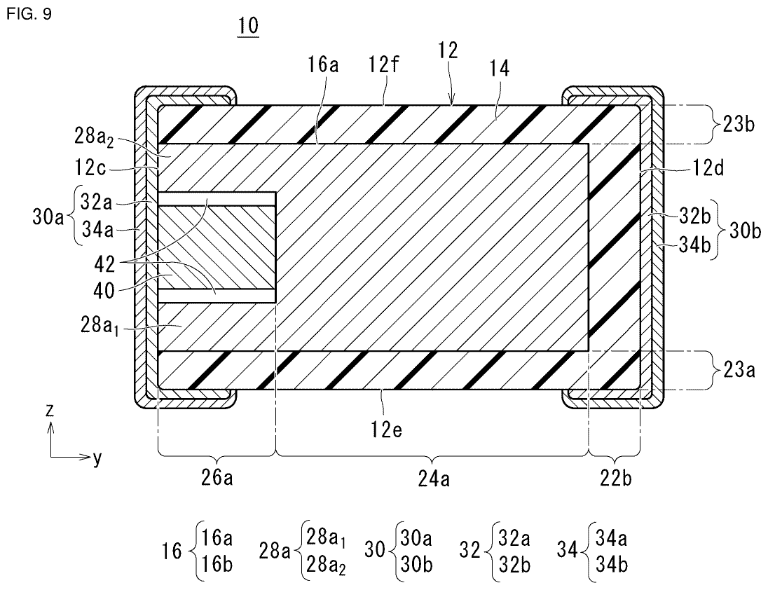

In an alternative configuration, as illustrated in FIG. 9, the first extended portion 28a1, and the shrinkage-mitigating portion 40 disposed in the first extended region 26a may not be connected to each other with the clearance region 42 provided therebetween, and the first extended portion 28a2, and the shrinkage-mitigating portion 40 disposed in the first extended region 26a may not be connected to each other with the clearance region 42 provided therebetween. In this case, the first opposed region 24a and the shrinkage-mitigating portion 40 are connected to each other.

The connection between the first opposed region 24a and the shrinkage-mitigating portion 40 allows for a wider current path in the first extended region 26a, which makes it possible to further improve resistance characteristics such as ESR, for example.

The shrinkage-mitigating portion 40 disposed in the first extended region 26a may be positioned to overlap a portion of the first opposed region 24a.

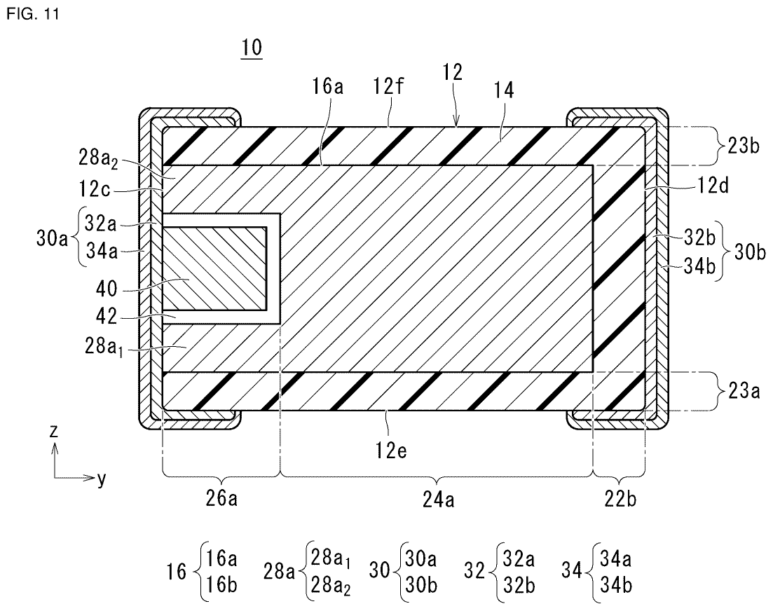

In a further alternative configuration, as illustrated in FIG. 11, the first opposed region 24a, and the shrinkage-mitigating portion 40 disposed in the first extended region 26a may not be connected to each other with the clearance region 42 provided therebetween, the first extended portion 28a1, and the shrinkage-mitigating portion 40 disposed in the first extended region 26a may not be connected to each other with the clearance region 42 provided therebetween, and the first extended portion 28a2, and the shrinkage-mitigating portion 40 disposed in the first extended region 26a may not be connected to each other with the clearance region 42 provided therebetween.

As described above, the clearance region 42 is provided between the shrinkage-mitigating portion 40 disposed in the first extended region 26a, and each of the first opposed region 24a and the first extended portion 28a. As a result, the first opposed region 24a and the shrinkage-mitigating portion 40 do not overlap, which makes it possible to reduce or prevent the risk of deterioration in reliability that would occur as an end portion of the first opposed region 24a is locally pressed down.

Preferably, for example, a dimension w₁ in the second direction z of the shrinkage-mitigating portion 40 disposed in the first extended region 26a, and a dimension w₂ in the second direction z of the first opposed region 24a satisfy about 0.5×w₂<w₁<about 0.9×w₂.

As will be described later, when the shrinkage-mitigating portion 40 includes, for example, Cr as its main metal component, increasing the dimension w₁ in the second direction z of the shrinkage-mitigating portion 40 allows for greater shrinkage mitigation. However, the resulting increase in the compositional proportion of Cr in the first extended region 26a leads to an increased resistance. Therefore, the dimension w₁ in the second direction Z of the shrinkage-mitigating portion 40 disposed in the first extended region 26a preferably satisfies the condition described above.

Preferably, a dimension l₁ in the first direction y of the shrinkage-mitigating portion 40 disposed in the first extended region 26a, and a dimension 12 between the first opposed region 24a and a first outer electrode 30a satisfy about 0.5×l₂<l₁<about 1.0×l₂.

Although increasing the dimension 11 in the first direction y of the shrinkage-mitigating portion 40 allows for greater shrinkage mitigation, this may result in an increased amount of overlap between the first opposed region 24a and the shrinkage-mitigating portion 40. This in turn increases the risk of deterioration in reliability that would occur as an end portion of the first opposed region 24a is locally pressed down. Therefore, the dimension 11 in the first direction y of the shrinkage-mitigating portion 40 disposed in the first extended region 26a preferably satisfies the condition mentioned above.

Although not particularly limited, the shape of the first opposed region 24a of the first inner electrode layer 16a is preferably a rectangular or substantially rectangular shape in plan view. The shape, however, may include rounded corners in plan view, or may include oblique (tapered) corners in plan view. Alternatively, the shape may be a tapered shape in plan view that is tapered toward one end.

The first opposed region 24a of the first inner electrode layer 16a, and the first extended region 26a of the first inner electrode layer 16a may have the same or substantially the same width, or one of the two regions may be narrower than the other.

Each second inner electrode layer 16b is disposed on the corresponding one of the dielectric layers 14, and located within the multilayer body 12. The second inner electrode layer 16b includes a second opposed region 24b and a second extended region 26b. The second opposed region 24b is a region opposed to the first inner electrode layer 16a. The second extended region 26b is a region that is located adjacent to one end of the second inner electrode layer 16b, and that extends from the second opposed region 24b to the fourth surface 12d.

The second extended region 26b includes a second extended portion 28b and the shrinkage-mitigating portion 40. The shrinkage-mitigating portion 40 of the second extended region 26b is disposed in a central portion of the second extended region 26b in the second direction z, and exposed on the fourth surface 12d. The second extended portion 28b is disposed in each end portion of the second extended region 26b in the second direction z, and exposed on the fourth surface 12d. The second extended portion 28b includes a second extended portion 28b1 located adjacent to the fifth surface 12e, and a second extended portion 28b2 located adjacent to the sixth surface 12f. Alternatively, the second extended portion 28b may be located adjacent to only one side portion of the second extended region 26b in the second direction Z.

The second opposed region 24b and the second extended portion 28b are preferably integral with each other.

The shrinkage-mitigating portion 40 disposed in the second extended region 26b is connected to the second extended portion 28b. Specifically, the shrinkage-mitigating portion 40 disposed in the second extended region 26b is connected at its edge adjacent to the fifth surface 12e to the second extended portion 28b1, and connected at its edge adjacent to the sixth surface 12f to the second extended portion 28b2.

As described above, the shrinkage-mitigating portion 40 disposed in the second extended region 26b is connected to the second extended portion 28b. This results in increased joint area with the outer electrode 30, which makes it possible to improve resistance characteristics such as ESR, for example.

The shrinkage-mitigating portion 40 disposed in the second extended region 26b may be positioned to overlap a portion of the second extended portion 28b.

Preferably, the second opposed region 24b, and the shrinkage-mitigating portion 40 disposed in the second opposed region 24b are not connected to each other, and the clearance region 42 is provided therebetween.

Due to the presence of the clearance region 42 between the second opposed region 24b, and the shrinkage-mitigating portion 40 disposed in the second extended region 26b, the second opposed region 24b and the shrinkage-mitigating portion 40 do not overlap. This makes it possible to reduce the risk of deterioration in reliability that would occur as an end portion of the second opposed region 24b is locally pressed down.

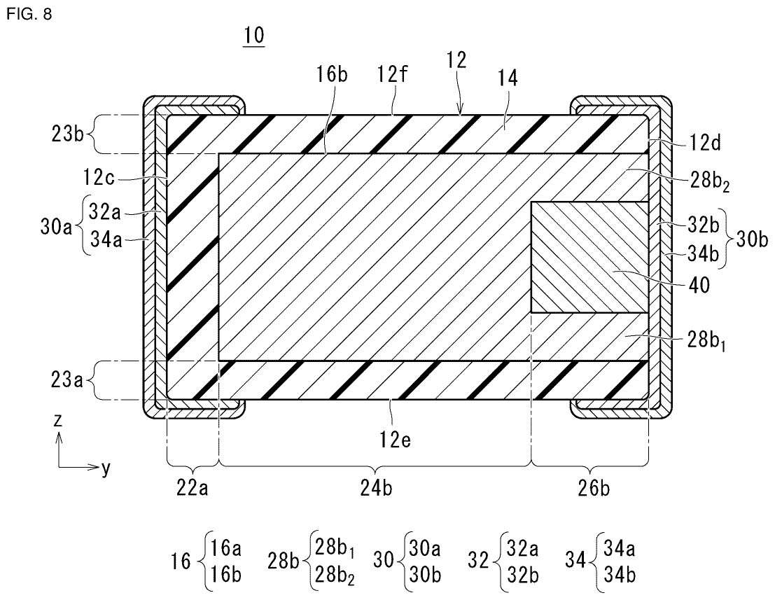

In an alternative configuration, as illustrated in FIG. 8, the second opposed region 24b, and the shrinkage-mitigating portion 40 disposed in the second extended region 26b may be connected to each other, and the second extended portion 28b, and the shrinkage-mitigating portion 40 disposed in the second extended region 26b may be connected to each other.

According to the above-described configuration, the second opposed region 24b, and the shrinkage-mitigating portion 40 disposed in the second extended region 26b are connected to each other, and the second extended portion 28b, and the shrinkage-mitigating portion 40 disposed in the second extended region 26b are connected to each other. This allows for a wider current path in the second extended region 26b, which makes it possible to further improve resistance characteristics such as ESR, for example.

The shrinkage-mitigating portion 40 disposed in the second extended region 26b may be positioned to overlap a portion of the second opposed region 24b and a portion of the second extended portion 28b.

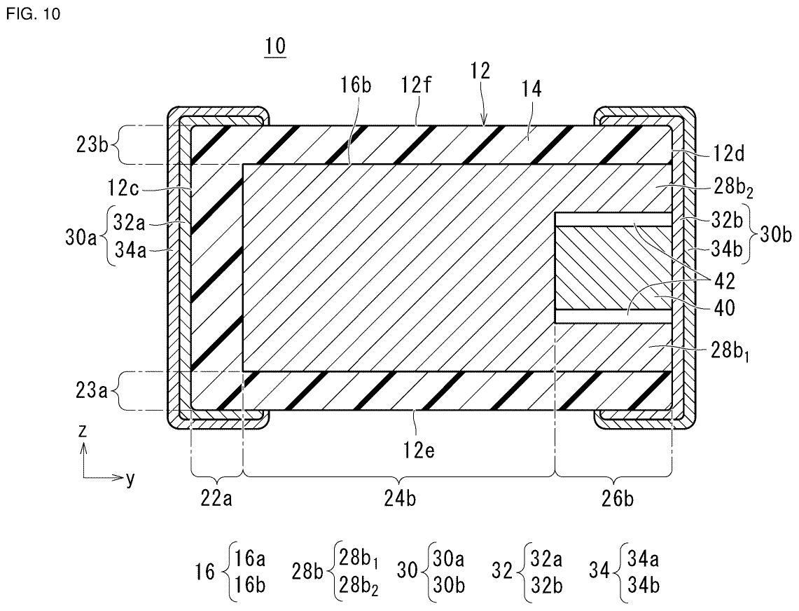

In an alternative configuration, as illustrated in FIG. 10, the second extended portion 28b1, and the shrinkage-mitigating portion 40 disposed in the second extended region 26b may not be connected to each other with the clearance region 42 provided therebetween, and the second extended portion 28b2, and the shrinkage-mitigating portion 40 disposed in the second extended region 26b may not be connected to each other with the clearance region 42 provided therebetween. In this case, the second opposed region 24b and the shrinkage-mitigating portion 40 are connected to each other.

The connection between the second opposed region 24b and the shrinkage-mitigating portion 40 allows for a wider current path in the second extended region 26b, which makes it possible to further improve resistance characteristics such as ESR, for example.

The shrinkage-mitigating portion 40 disposed in the second extended region 26b may be positioned to overlap a portion of the second opposed region 24b.

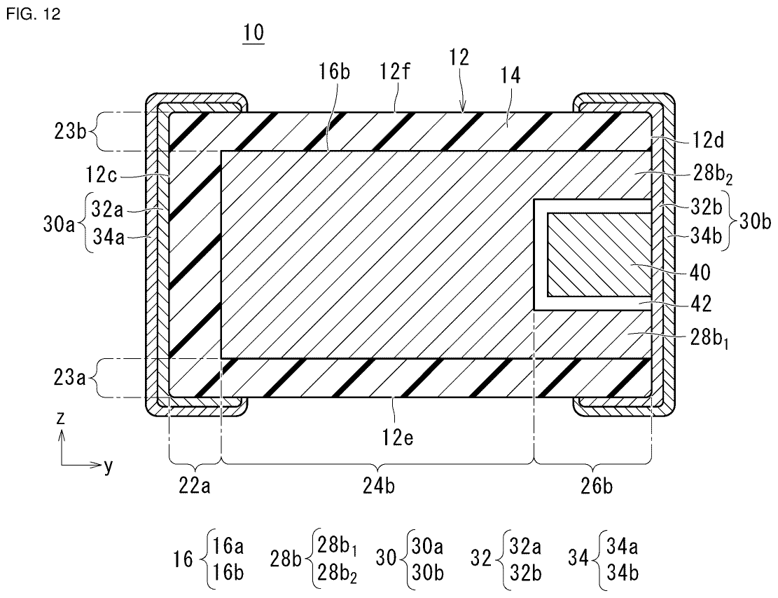

In a further alternative configuration, as illustrated in FIG. 12, the second opposed region 24b, and the shrinkage-mitigating portion 40 disposed in the second extended region 26b may not be connected to each other with the clearance region 42 provided therebetween, the second extended portion 28b1, and the shrinkage-mitigating portion 40 disposed in the second extended region 26b may not be connected to each other with the clearance region 42 provided therebetween, and the second extended portion 28b2, and the shrinkage-mitigating portion 40 disposed in the second extended region 26b may not be connected to each other with the clearance region 42 provided therebetween.

As described above, the clearance region 42 is provided between the shrinkage-mitigating portion 40 disposed in the second extended region 26b, and each of the second opposed region 24b and the second extended portion 28b. As a result, the second opposed region 24b and the shrinkage-mitigating portion 40 do not overlap, which makes it possible to reduce or prevent the risk of deterioration in reliability that would occur as an end portion of the second opposed region 24b is locally pressed down.

Preferably, for example, a dimension w₃ in the second direction z of the shrinkage-mitigating portion 40 disposed in the second extended region 26b, and a dimension w₄ in the second direction z of the second opposed region 24b satisfy about 0.5×w₄<w₃<about 0.9×w₄.

As will be described later, when the shrinkage-mitigating portion 40 includes Cr as its main metal component, for example, increasing the dimension w₃ in the second direction z of the shrinkage-mitigating portion 40 allows for greater shrinkage mitigation. However, the resulting increase in the compositional proportion of Cr in the second extended region 26b leads to an increased resistance. Therefore, the dimension w₃ in the second direction z of the shrinkage-mitigating portion 40 disposed in the second extended region 26b preferably satisfies the condition described above.

Preferably, for example, a dimension 13 in the first direction y of the shrinkage-mitigating portion 40 disposed in the second extended region 26b, and a dimension 14 between the second opposed region 24b and a second outer electrode 30b satisfy about 0.5×14<13<about 1.0× 14.

Although increasing the dimension 13 in the first direction y of the shrinkage-mitigating portion 40 allows for greater shrinkage mitigation, this may result in an increased amount of overlap between the second opposed region 24b and the shrinkage-mitigating portion 40. This in turn increases the risk of deterioration in reliability that would occur as an end portion of the second opposed region 24b is locally pressed down. Therefore, the dimension 13 in the first direction y of the shrinkage-mitigating portion 40 disposed in the second extended region 26b preferably satisfies the condition described above.

Although not particularly limited, the shape of the second opposed region 24b of the second inner electrode layer 16b is preferably a rectangular or substantially rectangular shape in plan view. The shape, however, may have rounded corners in plan view, or may have oblique (tapered) corners in plan view. Alternatively, the shape may be a tapered shape in plan view that is tapered toward one end.

The second opposed region 24b of the second inner electrode layer 16b, and the second extended region 26b of the second inner electrode layer 16b may have the same or substantially the same width, or one of the two regions may be narrower than the other.

Within the multilayer body 12, the first opposed region 24a of the first inner electrode layer 16a and the second opposed region 24b of the second inner electrode layer 16b are opposed to each other. According to the present example embodiment, as the first opposed region 24a of the first inner electrode layer 16a and the second opposed region 24b of the second inner electrode layer 16b are opposed to each other with the dielectric layer 14 interposed therebetween, capacitance is generated, which results in capacitor characteristics.

In this regard, for example, an Sn layer is present between the dielectric layer 14 and each of the first inner electrode layer 16a and the second inner electrode layer 16b. This helps to relieve electric field concentration at the interface between the inner electrode layer 16 and the dielectric layer 14, and leads to improved high-temperature load reliability.

The first and second inner electrode layers 16a and 16b each include, for example, Ni as a metal component.

In a preferred non-limiting example, the first inner electrode layer 16a has a thickness greater than or equal to about 0.50 μm and less than or equal to about 1.00 μm.

In a preferred non-limiting example, the second inner electrode layer 16b has a thickness greater than or equal to about 0.50 μm and less than or equal to about 1.00 μm.

In a preferred non-limiting example, the sum of the number of first inner electrode layers 16a and the number of second inner electrode layers 16b is greater than or equal to 280 and less than or equal to 1400.

In a preferred non-limiting example, the number of first inner electrode layers 16a is greater than or equal to 140 and less than or equal to 700.

In a preferred non-limiting example, the number of second inner electrode layers 16b is greater than or equal to 140 and less than or equal to 700.

The shrinkage-mitigating portion 40 includes, as its main component, a metal component that is less susceptible to shrinkage than the metal component of the inner electrode layer 16. In a preferred example, the main metal component of the shrinkage-mitigating portion 40 is Cr.

As described above, a metal component that is less susceptible to shrinkage than the metal component of the inner electrode layer 16 is used as the main metal component of the shrinkage-mitigating portion 40. This reduces or prevents the difference in shrinkage between the capacitance-generating portion 18 and each of the outer layer portions 20a and 20b and, consequently, makes it possible to reduce or prevent the occurrence of cracking within the multilayer body 12.

As described above, for example, when the inner electrode layer includes Ni as its metal component, the main metal component of the shrinkage-mitigating portion 40 is Cr, which has a higher melting point and undergoes less shrinkage than Ni. This reduces or prevents the difference in shrinkage between the capacitance-generating portion 18 and each of the outer layer portions 20a and 20b and, consequently, makes it possible to reduce or prevent the occurrence of cracking within the multilayer body 12.

Preferably, for example, the compositional proportion of the main metal component of the shrinkage-mitigating portion 40 is greater than or equal to about 70 mol %.

According to the above-described configuration, when the inner electrode layer includes Ni as its metal component, the compositional proportion of Cr, which has a higher melting point than Ni, is set to be greater than or equal to about 70 mol %. This reduces or prevents the difference in shrinkage between the capacitance-generating portion 18 and each of the outer layer portions 20a and 20b and, consequently, makes it possible to reduce or prevent the occurrence of cracking within the multilayer body 12.

As illustrated in FIG. 1, the outer electrode 30 is disposed on the third surface 12c and the fourth surface 12d of the multilayer body 12. The outer electrode 30 includes the first outer electrode 30a and the second outer electrode 30b.

The first outer electrode 30a is connected to the first inner electrode layer 16a, and exposed on at least the third surface 12c. The first outer electrode 30a extends from the third surface 12c of the multilayer body 12 such that the first outer electrode 30a is also disposed on a portion of the first surface 12a and a portion of the second surface 12b, as well as on a portion of the fifth surface 12e and a portion of the sixth surface 12f. In this case, the first outer electrode 30a is electrically connected to the first extended region 26a of the first inner electrode layer 16a.

The second outer electrode 30b is connected to the second inner electrode layer 16b, and exposed on at least the fourth surface 12d. The second outer electrode 30b extends from the fourth surface 12d of the multilayer body 12 such that the second outer electrode 30b is disposed also on a portion of the first surface 12a and a portion of the second surface 12b, as well as on a portion of the fifth surface 12e and a portion of the sixth surface 12f. In this case, the second outer electrode 30b is electrically connected to the second extended region 26b of the second inner electrode layer 16b.

The outer electrode 30 includes a base electrode layer 32 disposed on the surface of the multilayer body 12, and a plating layer 34 covering the base electrode layer 32.

The base electrode layer 32 includes a first base electrode layer 32a and a second base electrode layer 32b.

The plating layer 34 includes a first plating layer 34a and a second plating layer 34b.

In other words, the first outer electrode 30a includes the first base electrode layer 32a and the first plating layer 34a. The second outer electrode 30b includes the second base electrode layer 32b and the second plating layer 34b.

The first base electrode layer 32a is disposed on the third surface 12c of the multilayer body 12, and extends from the third surface 12c so as to cover a portion of the first surface 12a, a portion of the second surface 12b, a portion of the fifth surface 12e, and a portion of the sixth surface 12f.

The second base electrode layer 32b is disposed on the fourth surface 12d of the multilayer body 12, and extends from the fourth surface 12d so as to cover a portion of the first surface 12a, a portion of the second surface 12b, a portion of the fifth surface 12e, and a portion of the sixth surface 12f.

Alternatively, the first base electrode layer 32a may be disposed only on the third surface 12c of the multilayer body 12, or the second base electrode layer 32b may be disposed only on the fourth surface 12d of the multilayer body 12.

The base electrode layer 32 includes at least one of, for example, a baked layer, a conductive resin layer, or a thin film layer.

The following describes the configuration of the base electrode layer 32 for each of the above-mentioned cases of a baked layer, a conductive resin layer, or a thin film layer.

A baked layer includes a glass component and a metal component. The glass component of the baked layer includes at least one of, for example, B, Si, Ba, Mg, Al, or Li. The metal component of the baked layer includes at least one of, for example, Cu, Ni, Ag, Pd, an Ag—Pd alloy, or Au. The baked layer may include a plurality of layers. The baked layer is obtained by applying and baking a conductive paste including the glass component and the metal component onto the multilayer body 12.

When the first base electrode layer 32a is provided as the baked layer, the first base electrode layer 32a on the third surface 12c preferably has, in its central portion in the stacking direction x, a thickness in a range of, for example, greater than or equal to about 20 μm and less than or equal to about 170 μm.

When the second base electrode layer 32b is provided as the baked layer, the second base electrode layer 32b on the fourth surface 12d preferably has, in its central portion in the stacking direction x, a thickness in a range of, for example, greater than or equal to about 20 μm and less than or equal to about 170 μm.

When the base electrode layer 32 is provided as the baked layer on the first surface 12a and the second surface 12b, the first base electrode layer 32a on each of the first surface 12a and the second surface 12b preferably has, in its central portion in the first direction y, a thickness in a range of, for example, greater than or equal to about 5 μm and less than or equal to about 40 μm in a direction connecting the first surface 12a and the second surface 12b, and the second base electrode layer 32b on each of the first surface 12a and the second surface 12b preferably has, in its central portion in the first direction y, a thickness in a range of, for example, greater than or equal to about 5 μm and less than or equal to about 40 μm in the direction connecting the first surface 12a and the second surface 12b.

Further, when the base electrode layer 32 is provided as the baked layer on the fifth surface 12e and the sixth surface 12f, the first base electrode layer 32a on each of the fifth surface 12e and the sixth surface 12f preferably has, in its central portion in the first direction y, a thickness in a range of, for example, greater than or equal to about 5 μm and less than or equal to about 40 μm in a direction connecting the fifth surface 12e and the sixth surface 12f, and the second base electrode layer 32b on each of the fifth surface 12e and the sixth surface 12f preferably has, in its central portion in the first direction y, a thickness in a range of, for example, greater than or equal to about 5 μm and less than or equal to about 40 μm in the direction connecting the fifth surface 12e and the sixth surface 12f.

When a conductive resin layer is provided as the base electrode layer 32, the conductive resin layer may be disposed on the baked layer so as to cover the baked layer, or may be disposed directly on the multilayer body 12 with no baked layer provided therebetween. The conductive resin layer may completely cover the baked layer, or may cover a portion of the baked layer. Further, the conductive resin layer includes a plurality of layers.

The conductive resin layer includes a metal and a thermosetting resin. Since the conductive resin layer includes a thermosetting resin, the conductive resin layer is more flexible than, for example, a plating film or a baked layer made from a fired conductive paste. Consequently, even when the multilayer ceramic capacitor 10 is subjected to a physical shock or a shock caused by thermal cycling, the conductive resin layer functions as a shock-absorbing layer to prevent cracking in the multilayer ceramic capacitor 10.

As the metal included in the conductive resin layer, for example, Ag, Cu, Ni, Sn, Bi, or an alloy including such metals may be used. Alternatively, for example, a metal powder with an Ag-coated surface may be used. When a metal powder with an Ag-coated surface is to be used, for example, a metal powder of Cu, Ni, Sn, Bi, or an alloy thereof is preferably used. A reason why a conductive metal powder of Ag is used for a conductive metal is that Ag has the lowest resistivity of all metals, which makes Ag suitable as an electrode material, and Ag is a noble metal, which means that Ag does not oxidize and has high weather resistance. Another reason is that using a conductive metal powder of Ag makes it possible to use an inexpensive base metal while maintaining the above-mentioned characteristics of Ag.

Further, as the metal included in the conductive resin layer, for example, Cu or Ni that has undergone anti-oxidation treatment may be used. Alternatively, for example, as the metal included in the conductive resin layer, a metal powder with a surface coated with Sn, Ni, or Cu may be used. When a metal powder with a surface coated with Sn, Ni, or Cu is to be used, for example, a metal powder of Ag, Cu, Ni, Sn, Bi, or an alloy thereof is preferably used.

The metal included in the conductive resin layer is mainly responsible for the electrical conductivity of the conductive resin layer. Specifically, as the conductive fillers come into contact with each other, a conductive path is provided within the conductive resin layer.

Although the metal included in the conductive resin layer may be spherical or flat-shaped, it is preferable to use a mixture of a spherical metal powder and a flat-shaped metal powder.

Examples of the resin used for the conductive resin layer may include various known thermosetting resins such as an epoxy resin, a phenolic resin, a urethane resin, a silicone resin, or a polyimide resin. Of these, an epoxy resin is one of the preferable resins due to its excellent properties in terms of, for example, heat resistance, moisture resistance, and adhesion.

The conductive resin layer preferably includes a curing agent in addition to the thermosetting resin. When an epoxy resin is to be used as the base resin, examples of the curing agent that may be used for the epoxy resin may include various known compounds including phenolic compounds, amine compounds, acid anhydride compounds, imidazole compounds, active ester compounds, or amide-imide compounds.

The thickest portion of the conductive resin layer preferably has, for example, a thickness greater than or equal to about 20 μm and less than or equal to about 100 μm.

When a thin film layer is provided as the base electrode layer 32, the thin film layer is formed by a thin film deposition method such as, for example, sputtering or vapor deposition as a layer of deposited metal particles that has a thickness of less than or equal to about 1 μm.

The plating layer 34 includes the first plating layer 34a and the second plating layer 34b.

The first plating layer 34a is disposed so as to cover the surface of the first base electrode layer 32a.

The second plating layer 34b is disposed so as to cover the surface of the second base electrode layer 32b.

The plating layer 34 includes at least one metal, such as, for example, Cu, Ni, Sn, Ag, Pd, an Ag—Pd alloy, or Au.

The plating layer 34 may include a single layer, or may include a plurality of layers. When the plating layer 34 includes a plurality of layers, the plating layer 34 preferably has a two-layer structure including, for example, a Ni plating layer and a Sn plating layer. Using a Ni plating layer as the layer in direct contact with the base electrode layer makes it possible to, particularly when the base electrode layer is a conductive resin layer, prevent the base electrode layer from being eroded by the solder used in mounting the multilayer ceramic capacitor.

Forming a Sn plating layer on top of a Ni plating layer as described above makes it possible to, in mounting the multilayer ceramic capacitor 10 to a mounting substrate, improve the wettability of the solder used for the mounting and thus facilitate the mounting.

Each single plating layer 34 preferably has a thickness greater than or equal to about 1.5 μm and less than or equal to about 5.0 μm, for example.

In an alternative configuration, the outer electrode 30 may include only a plating layer without including any base electrode layer 32.

Although not illustrated, a structure including a plating layer provided without the base electrode layer 32 will now be described.

Each of the first outer electrode 30a and the second outer electrode 30b may include a plating layer provided directly on the surface of the multilayer body 12 without the base electrode layer. That is, the multilayer ceramic capacitor 10 may include a plating layer electrically connected to the first inner electrode layer 16a or the second inner electrode layer 16b. In this case, as a pretreatment process, a catalyst may be provided on the surface of the multilayer body 12 before the plating layer is formed.

In a case where the plating layer is provided directly on the multilayer body without the base electrode layer, the thickness saved by omitting the base electrode layer 32 can be used to achieve height reduction, that is, thickness reduction, or to increase the thickness of the multilayer body 12, that is, the thickness of the capacitance-generating portion. This allows for increased design flexibility of a thin chip.

The plating layer preferably includes a lower-layer plating electrode provided on the surface of the multilayer body 12, and an upper-layer plating electrode provided on the surface of the lower-layer plating electrode. The lower-layer plating electrode and the upper-layer plating electrode each preferably include at least one metal, such as, for example, Cu, Ni, Sn, Pb, Au, Ag, Pd, Bi, or Zn, or an alloy including the at least one metal.

Further, for example, the lower-layer plating electrode is preferably made of Ni, which has solder barrier properties, and the upper-layer plating electrode is preferably made of Sn or Au, which has superior solder wettability.

When the first inner electrode layer 16a and the second inner electrode layer 16b are made of Ni, the lower-layer plating electrode is preferably made of Cu, for example, which bonds well to Ni. The upper-layer plating electrode may be provided on an as-needed basis. Thus, each of the first outer electrode 30a and the second outer electrode 30b may include only the lower-layer plating electrode. The plating layer may include the upper-layer plating electrode as the outermost layer, or may include another plating electrode provided on the surface of the upper-layer plating electrode.

When the outer electrode 30 includes only plating layers without the base electrode layer 32, each single plating layer to be disposed without the base electrode layer 32 preferably has a thickness greater than or equal to about 1.0 μm and less than or equal to about 15.0 μm, for example.

Further, the plating layer preferably includes no glass. The metal content per unit volume of the plating layer is preferably greater than or equal to about 99% by volume, for example.

The multilayer ceramic capacitor 10 has a dimension L in the first direction y. The dimension L is preferably greater than or equal to about 1.00 mm and less than or equal to about 3.50 mm, for example. The dimension L may be greater than or equal to about 0.10 mm and less than or equal to about 3.50 mm, for example.

The multilayer ceramic capacitor 10 has a dimension T in the stacking direction x. The dimension T is preferably greater than or equal to about 0.50 mm and less than or equal to about 2.80 mm, for example. The dimension T may be greater than or equal to about 0.05 mm and less than or equal to about 2.80 mm, for example.

The multilayer ceramic capacitor 10 has a dimension W in the second direction z. The dimension W is preferably greater than or equal to about 0.50 mm and less than or equal to about 2.80 mm, for example. The dimension W may be greater than or equal to about 0.05 mm and less than or equal to about 2.80 mm, for example.

In the multilayer ceramic capacitor 10 in FIG. 1, the first extended region 26a includes the first extended portion 28a and the shrinkage-mitigating portion 40, and the second extended region 26b includes the second extended portion 28b and the shrinkage-mitigating portion 40. The shrinkage-mitigating portion 40 includes, as its main component, a metal component that is less susceptible to shrinkage than the metal component of the inner electrode layer 16. As described above, a metal component that is less susceptible to shrinkage than the metal component of the inner electrode layer 16 is used as the main metal component of the shrinkage-mitigating portion 40. This reduces or prevents the difference in shrinkage between the capacitance-generating portion 18 and each of the outer layer portions 20a and 20b. This in turn makes it possible to reduce or prevent the occurrence of cracking within the multilayer body 12. The shrinkage-mitigating portion 40 is disposed in the central portion of the first extended region 26a in the second direction z, and in the central portion of the second extended region 26b in the second direction z. As described above, the shrinkage-mitigating portion 40 is disposed in the central portion, which is a portion susceptible to the influence of shrinkage. This reduces or prevents the difference in shrinkage between the capacitance-generating portion 18 and each of the outer layer portions 20a and 20b. This in turn makes it possible to reduce or prevent the occurrence of cracking within the multilayer body 12.

An example of a method for manufacturing a multilayer ceramic capacitor according to an example embodiment of the present invention will now be described.

First, dielectric sheets for forming the dielectric layers, and a conductive paste for forming the inner electrode layers are prepared. The dielectric sheets, and the conductive paste for forming the inner electrode layers each include a binder and a solvent. A known binder and a known solvent may be used in this case.

The conductive paste for forming the inner electrode layers is applied in a predetermined pattern onto the dielectric sheets by, for example, a method such as screen printing or gravure printing. As a result, dielectric sheets provided with the pattern of the first inner electrode layer, and dielectric sheets provided with the pattern of the second inner electrode layer are prepared.

More specifically, a gravure cylinder for printing the first and second inner electrode layers is prepared, and the pattern of each inner electrode layer can be printed by use of a gravure printing machine, for example.

As for the dielectric sheets, dielectric sheets used for forming the outer layer and not provided with the pattern of the inner electrode layer are also prepared.

At this time, the conductive paste for forming the inner electrode layers is not applied to the area where the shrinkage-mitigating portion disposed in each of the first extended region and the second extended region is to be formed. Accordingly, for each of the first extended region and the second extended region, for example, a metal film of Cr that will become the shrinkage-mitigating portion 40 is deposited by sputtering onto an area to which the conductive paste for forming the inner electrode layers is not applied. In depositing the metal film of Cr, for example, masking is applied such that the metal film of Cr is not deposited onto an area that has been printed with the pattern of the inner electrode layer. In this regard, at the junction between the area printed with the pattern of the inner electrode layer, and the metal film of Cr defining and functioning as the shrinkage-mitigating portion 40, the metal film of Cr defining and functioning as the shrinkage-mitigating portion 40 may overlap a portion of the pattern of the inner electrode layer.

Subsequently, a predetermined number of dielectric sheets with no pattern of the inner electrode layer printed thereon are stacked to form a portion that will become the second outer layer portion 20b located adjacent to the second surface 12b. Subsequently, on top of the portion that will become the second outer layer portion, ceramic green sheets printed with the pattern of the first inner electrode layer, and ceramic green sheets printed with the pattern of the second inner electrode layer are sequentially stacked so as to provide the structure according to an example embodiment of the present invention. Thus, a portion that will become the capacitance-generating portion is formed. On top of the portion that will become the capacitance-generating portion, a predetermined number of dielectric sheets with no pattern of the inner electrode layer printed thereon are stacked to thus form a portion that will become the first outer layer portion 20a located adjacent to the first surface 12a. A sheet stack is thus produced.

Subsequently, the sheet stack is pressed in the stacking direction by, for example, isostatic pressing or other methods, and a multilayer block is thus produced.

Subsequently, the multilayer block is cut into portions of a predetermined size to obtain each individual multilayer chip. At this time, the corners and edges of the multilayer chip may be rounded by, for example, barrel finishing or other methods.

Subsequently, the obtained multilayer chip is subjected to firing to produce the multilayer body 12. Although depending on the material of the dielectric layer 14 and the inner electrode layer 16, the firing temperature is preferably higher than or equal to about 900° C. and lower than or equal to about 1400° C., for example.

The following describes a case where the base electrode layer is formed by a baked layer. In forming the baked layer, a conductive paste including a glass component and a metal is prepared, and after the conductive paste is applied, the applied conductive paste is subjected to baking to thus form the base electrode layer.

The first base electrode layer 32a of the first outer electrode 30a, and the second base electrode layer 32b of the second outer electrode 30b are formed on the third surface 12c and the fourth surface 12d, respectively, of the multilayer body 12 obtained by firing.

In a case where a baked layer is to be formed as the base electrode layer 32, a conductive paste including a glass component and a metal component is applied by, for example, dipping or other methods, and then the applied conductive paste is subjected to baking. A baked layer is thus formed as the base electrode layer 32. The baking temperature at this time is preferably higher than or equal to about 700° C. and lower than or equal to about 900° C., for example. According to the example embodiment, the base electrode layer 32 is formed as a baked layer.

In a case where the base electrode layer 32 is to be formed as a conductive resin layer, the conductive resin layer may be formed by, for example, a method described below. The conductive resin layer may be formed on the surface of a baked layer, or the conductive resin layer alone may be formed directly on the multilayer body 12 with no baked layer provided therebetween.

The conductive resin layer is formed by applying a conductive resin paste including a thermosetting resin and a metal component onto a baked layer or onto the multilayer body 12, and performing heat treatment at a temperature higher than or equal to about 250° C. and lower than or equal to about 550° C., for example, to heat-cure the resin. The heat treatment at this time is preferably performed under a N₂ atmosphere, for example. To prevent scattering of the resin and oxidation of various metal components, the oxygen concentration is preferably controlled to be lower than or equal to about 100 ppm, for example.

With regard to the method for applying the conductive resin paste, as with the method for forming the base electrode layer 32 as a baked layer, for example, the conductive resin paste may be formed by the dipping method.

In a case where the base electrode layer 32 is to be formed as a thin film layer, the base electrode layer can be formed by, for example, applying masking or the like to cover areas except for a desired location where the outer electrode 30 is to be formed, and applying a thin film deposition method such as sputtering or vapor deposition to the desired location that is left exposed. The base electrode layer thus formed as a thin film layer is a layer of deposited metal particles that has a thickness less than or equal to about 1 μm, for example.

Lastly, the plating layer 34 is formed. The plating layer 34 may be formed on the surface of the base electrode layer 32, or may be formed directly on the multilayer body 12. According to the present example embodiment, the plating layer 34 is formed on the surface of the base electrode layer 32. More specifically, for example, over the base electrode layer 32, a Ni plating layer and a Sn plating layer are formed as a lower plating layer and an upper plating layer, respectively. In performing plating, either electrolytic plating or electroless plating may be used. It is to be noted, however, that electroless plating requires pretreatment with a catalyst or the like to improve the plating deposition rate, which disadvantageously makes the overall process more complex. Therefore, it is usually preferred to use electrolytic plating.

The multilayer ceramic capacitor 10 according to the present example embodiment is thus manufactured as described above.

Subsequently, to determine the advantageous effects of the above-described multilayer ceramic capacitor according to an example embodiment of the present invention, an experiment is conducted on how the amount of depression on the third surface or the fourth surface of the multilayer body, and the rate of occurrence of delamination within the multilayer body change with respect to changes in the compositional ratio of Ni to Cr in the shrinkage-mitigating portion, and these quality characteristics are thus determined.

Multilayer ceramic capacitor samples according to Comparative Example and Examples 1 to 4 are fabricated by the example of the manufacturing method according to the present example embodiment described above.
Structure of Multilayer Ceramic Capacitor: Multilayer Ceramic Capacitor Illustrated in FIG. 1.
Dimension of Multilayer Ceramic Capacitor in First Direction: about 3.450 mm
Dimension of Multilayer Ceramic Capacitor in Second Direction: about 1.850 mm
Dimension of Multilayer Ceramic Capacitor in Stacking Direction: about 1.850 mm
Thickness of Dielectric Layers: about 0.87 μm
Thickness of Inner Electrode Layers: about 0.59 μm
Number of First Inner Electrode Layers: 530.
Number of Second Inner Electrode Layers: 530.
Thickness Of First Outer Layer portion: about 75 μm
Thickness Of Second Outer Layer portion: about 75 μm.
Dimension Of L-Gap: about 90 μm
Dimension Of W-Gap: about 70 μm

Samples according to Examples are fabricated by the example of the method for manufacturing the multilayer ceramic capacitor according to the present example embodiment. Samples of a multilayer body with a shrinkage-mitigating portion disposed in its extended region are fabricated. As Comparative Example, samples of a multilayer body with no shrinkage-mitigating portion are fabricated.

The geometry data of the third surface or the fourth surface is acquired with a laser microscope (VK-1000 from Keyence Corporation) to determine the amount of deformation. The amount of deformation is measured as the difference between the most projected portion and the most depressed portion of the third surface or the fourth surface. The number of samples is set to 5.

The appearance of the third surface or the fourth surface of each multilayer body sample after firing is observed to determine whether delamination is present. The number of samples is set to 20000.

The evaluation results are presented in Table 1.

Table 1 presents the determination results on the amount of depression on the third surface or the fourth surface of the multilayer body and on the rate of occurrence of delamination within the multilayer body, with respect to changes in the compositional ratio of Ni to Cr in the shrinkage-mitigating portion.

TABLE 1

| | Dimension w₁ in | Dimension l₁ in | | | |
|---|---|---|---|---|---|
| | second direction of | first direction of | | | |
| | shrinkage-mitigating | shrinkage-mitigating | | Amount of | |
| | portion relative | portion relative | Compositional ratio | depression on | Rate of |
| | to dimension w₂ | to dimension 1₂ | of Ni to Cr in | third surface or | occurrence of |
| | in second direction | between opposed region | shrinkage-mitigating | fourth surface | delamination |
| | of opposed region | and outer electrode | portion (mol %) | (μm) | (ppm) |
| Comparative | N/A | N/A | N/A | 7.0 | 250 |
| Example | | | | | |
| Example 1 | 0.7 × w₂ | 0.9 × 1₂ | Ni:Cr = 30:70 | 6.7 | 200 |
| Example 2 | 0.7 × w₂ | 0.9 × 1₂ | Ni:Cr = 25:75 | 6.5 | 200 |
| Example 3 | 0.7 × w₂ | 0.9 × 1₂ | Ni:Cr = 15:85 | 6.1 | 150 |
| Example 4 | 0.7 × w₂ | 0.9 × 1₂ | Ni:Cr = 0:100 | 5.5 | 150 |

It can be confirmed from Table 1 that for Examples 1 to 4, with regard to the materials of the shrinkage-mitigating portion, decreasing the content of Ni and increasing the content of Cr, which is less susceptible to shrinkage than Ni, makes it possible to reduce the amount of deformation (amount of depression) on the third surface or the fourth surface, and reduce the rate of occurrence of delamination within the multilayer body. Further, it can be confirmed that setting the compositional proportion of Cr in the shrinkage-mitigating portion to be greater than or equal to, for example, about 70 mol % makes it possible to reduce the amount of deformation (amount of depression) on the third surface or the fourth surface, and reduce the rate of occurrence of delamination within the multilayer body.

In contrast, it is confirmed that for Comparative Example, due to the absence of the shrinkage-mitigating portion in the extended region, an increased amount of deformation (amount of depression) and an increased rate of occurrence of delamination within the multilayer body are observed relative to Examples 1 to 4.

It is confirmed from the above results that, by providing the shrinkage-mitigating portion in the extended region, and using, as the main metal component of the shrinkage-mitigating portion, a metal component that is less susceptible to shrinkage than the metal component of the inner electrode layers, the difference in shrinkage between the outer layer portion and the capacitance-generating portion is reduced or prevented, and the occurrence of delamination within the multilayer body can thus be reduced or prevented.

Although example embodiments of the present invention have been disclosed in the foregoing description, the disclosed example embodiments are not intended to be limiting of the present invention.

Various changes and modifications can be made to the above-described example embodiments of the present invention with regard to features such as configurations, shapes, materials, quantities, locations, or arrangements, including those described above, without departing from the technical idea and scope of the present invention, and such changes and modifications fall within the scope of the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of dielectric layers that are stacked, a plurality of inner electrode layers each stacked on a corresponding one of the plurality of dielectric layers, a first surface, a second surface, a third surface, a fourth surface, a fifth surface, and a sixth surface, the first surface and the second surface being opposed to each other in a stacking direction, the third surface and the fourth surface being opposed to each other in a first direction orthogonal or substantially orthogonal to the stacking direction, the fifth surface and the sixth surface being opposed to each other in a second direction orthogonal or substantially orthogonal to the stacking direction and to the first direction;
a first inner electrode layer on a corresponding one of the plurality of dielectric layers and extending to the third surface;
a second inner electrode layer on a corresponding one of the plurality of dielectric layers and extending to the third surface;
a first outer electrode on the third surface and connected to the first inner electrode layer; and
a second outer electrode on the fourth surface and connected to the second inner electrode layer; wherein
the first inner electrode layer includes a first opposed region opposed to the second inner electrode layer, and a first extended region located between the first opposed region and the third surface;
the second inner electrode layer includes a second opposed region opposed to the first inner electrode layer, and a second extended region located between the second opposed region and the fourth surface;
the first extended region includes a first extended portion connected to the first outer electrode;
the second extended region includes a second extended portion connected to the second outer electrode; and
the first extended region and the second extended region each include a shrinkage-mitigating portion located in a central portion in the second direction and exposed on at least one of the third surface or the fourth surface, the shrinkage-mitigating portion including a main metal component less susceptible to shrinkage than a metal component of each of the first inner electrode layer and the second inner electrode layer.

2. The multilayer ceramic capacitor according to claim 1, wherein
the metal component of each of the first inner electrode layer and the second inner electrode layer includes Ni; and
the main metal component of the shrinkage-mitigating portion includes Cr.

3. The multilayer ceramic capacitor according to claim 2, wherein a compositional proportion of the main metal component of the shrinkage-mitigating portion is greater than or equal to about 70 mol %.

4. The multilayer ceramic capacitor according to claim 1, wherein
the shrinkage-mitigating portion is connected to the first extended portion and the second extended portion; and
a clearance region is provided between the shrinkage-mitigating portion and at least one of the first opposed region or the second opposed region.

5. The multilayer ceramic capacitor according to claim 1, wherein the shrinkage-mitigating portion is connected to the first extended portion and the second extended portion, and connected to the first opposed region and the second opposed region.

6. The multilayer ceramic capacitor according to claim 1, wherein
the shrinkage-mitigating portion is connected to the first opposed region and the second opposed region; and
a clearance region is provided between the shrinkage-mitigating portion and at least one of the first extended portion or the second extended portion.

7. The multilayer ceramic capacitor according to claim 1, wherein
a clearance region is provided between the shrinkage-mitigating portion and at least one of the first opposed region or the second opposed region; and
a clearance region is provided between the shrinkage-mitigating portion and at least one of the first extended portion or the second extended portion.

8. The multilayer ceramic capacitor according to claim 1, wherein a dimension w₁ in the second direction of the shrinkage-mitigating portion, and a dimension w₂ in the second direction of each of the first opposed region and the second opposed region satisfy about 0.5×w₂<w₁<about 0.9×w₂.

9. The multilayer ceramic capacitor according to claim 1, wherein a dimension 11 in the first direction of the shrinkage-mitigating portion, and a dimension 12 in the first direction between the first opposed region and the first outer electrode or between the second opposed region and the second outer electrode satisfy about 0.5×l₂<l₁<about 1.0×l₂.

10. The multilayer ceramic capacitor according to claim 1, wherein each of the plurality of dielectric layers includes BaTiO₃, CaTiO₃, SrTiO₃, or CaZrO₃ as a main component.

11. The multilayer ceramic capacitor according to claim 10, wherein each of the plurality of dielectric layers includes a Mn compound, an Fe compound, a Cr compound, a Co compound, or a Ni compound as a minor component.

12. The multilayer ceramic capacitor according to claim 1, wherein a thickness of each of the plurality of dielectric layers is greater than or equal to about 0.50 μm and less than or equal to about 3.00 μm.

13. The multilayer ceramic capacitor according to claim 1, wherein a shape of the first opposed region is rectangular or substantially rectangular.

14. The multilayer ceramic capacitor according to claim 1, wherein a shape of the second opposed region is rectangular or substantially rectangular.

15. The multilayer ceramic capacitor according to claim 1, wherein the first opposed region and the first extended region are integral with each other.

16. The multilayer ceramic capacitor according to claim 1, wherein the second opposed region and the second extended region are integral with each other.

17. The multilayer ceramic capacitor according to claim 1, wherein each of the first and second inner electrode layers is about 0.50 μm and less than or equal to about 1.00 μm.

18. The multilayer ceramic capacitor according to claim 1, wherein each of the first and second outer electrodes includes a base electrode layer and a plating layer on the base electrode layer.

19. The multilayer ceramic capacitor according to claim 18, wherein the base electrode layer includes at least one of a baked layer, a conductive resin layer, or a thin film layer.

20. The multilayer ceramic capacitor according to claim 18, wherein the base electrode layer includes a glass component and a metal component.
